(19) United States
(12) Patent Application Publication
(10) Pub. No.: US 2021/0123516 A1
(43) Pub. Date: Apr. 29, 2021

(54) LOW-NOISE LIFTING DEVICE

(71) Applicant: WEN-PIN WANG, TAINAN CITY (TW)

(72) Inventor: WEN-PIN WANG, TAINAN CITY (TW)

(21) Appl. No.: 16/661,282

(22) Filed: Oct. 23, 2019

(51) Int. Cl. F16H 55/26; A47B 9/06

(52) U.S. Cl. CPC F16H 55/26; A47B 2009/065; A47B 9/06

(57) ABSTRACT

A low-noise lifting device includes a rack and a gear. The rack includes first teeth each having a first crown portion. A surface of the first crown portion is defined as a first contact surface having a circular arc shape. The gear includes second teeth. A second root portion is defined between every adjacent two of the second teeth. A surface of the second root portion is defined as a second contact surface having a circular arc shape. When the gear is meshed with the rack, the second contact surface and the first contact surface are in close contact with each other in a circular arc shape, without a backlash, so as to reduce the noise generated by the transmission.

### FIELD OF THE INVENTION

The present invention relates to a low-noise lifting device, and more particularly to a rack and a gear that are in close contact with each other and can reduce the noise generated by the transmission.

### BACKGROUND OF THE INVENTION

A table having a lifting unit is developed on the market, such as Taiwan Patent Publication No. 1662919 titled “Table Lifting Structure” published on Jun. 21, 2019. The inner tubes of the table legs can be moved up and down synchronously, smoothly, unbiasedly in the hollow outer tubes, so that the height of the tabletop mounted on the inner tubes of the table legs can be adjusted easily.

The above-mentioned patent mainly utilizes the meshing structure of the rack (guide rack) and the gear (guide gear), so that the inner tubes can be synchronously moved up and down in the hollow outer tubes for adjusting the height of the tabletop. In the process of the transmission between the rack and the gear of the above-mentioned patent, a gap (backlash) is formed between the teeth of the rack and the gear when they are meshed with each other. The presence of the gap leads to noises, which causes troubles in the process of lifting and lowering the table.

Taiwan Utility Model Publication No. 529682 titled “Resistance-Type Gear Backlash Eliminating Structure” published on Apr. 21, 2003, which can improve the noise generated by the transmission of the rack and the gear. The teeth of the gear and the teeth of the damping gear can be adjusted to be interlaced and meshed with the teeth of the rack, so that no gap is formed in the teeth of the rack, thereby eliminating the backlash of the gear and the rack and solving the problems of inaccurate transmission, chattering, looseness, and transmission noise. In the above-mentioned patent, the damping gear is worn after used a period of time, and the wear is uneven due to the uneven force during the transmission, which leads to a gap. This is not ideal in use.

### SUMMARY OF THE INVENTION

In view of the above shortcomings of the prior art, the primary object of the present invention is to provide a low-noise lifting device. The low-noise lifting device comprises a rack and a gear. The rack includes a plurality of first teeth arranged in a straight line. Each of the first teeth has a first crown portion. The first crown portion is defined by a range between any two adjacent first nodes. A surface of the first crown portion is defined as a first contact surface having a circular arc shape. A first root portion is defined between the first crown portions of every adjacent two of the first teeth. The gear is in mesh with the rack. The gear includes a plurality of second teeth arranged around the gear. A second root portion is defined between every adjacent two of the second teeth. The second root portion is defined by a range between any two adjacent second nodes. A surface of the second root portion is defined as a second contact surface having a circular arc shape. Each of the second teeth has a second crown portion. When the gear is meshed with the rack, the second contact surface and the first contact surface are in close contact with each other in a circular arc shape.

The above technical features have the following advantages:

1. Because the first contact surface of the first crown portion of the rack is close contact with the second contact surface of the second root portion of the gear, without any backlash at all, in the transmission process, the transmission of the first teeth and the second teeth can be relatively smooth, so as to reduce the noise.

2. When the gear is meshed with the rack, the second non-contact surface is not in contact with the first non-contact surface, so that no noise is generated.

3. The second contact surface and the first contact surface are in close contact with each other in a circular arc shape, so that there is no disadvantage of uneven force. It does not cause wear or damage to the first teeth and the second teeth, so the present invention can prolong the service life and is suitable for use in the lifting unit of any table.

4. The side of the rack is provided with the fixing portion that extends perpendicularly relative to the rack. The cross-section of the fixing portion may be in a different shape for a guide block with a different configuration to abut against the fixing portion.

### BRIEF DESCRIPTION OF THE DRAWINGS

FIG. 1 is an exploded view in accordance with a first embodiment of the present invention;

FIG. 2 is a front view of the rack and the gear in accordance with the first embodiment of the present invention;

FIG. 3 is a schematic view of the rack and the gear to mesh with each other in accordance with the first embodiment of the present invention;

FIG. 4 is a schematic view of the first embodiment of the present invention used for lifting and lowering a table;

FIG. 5 is a schematic view showing the transmission of the rack and the gear in accordance with the first embodiment of the present invention;

FIG. 6 is an exploded view in accordance with a second embodiment of the present invention;

FIG. 7 is a schematic view of the second embodiment of the present invention used for lifting and lowering a table;

FIG. 8 is an exploded view in accordance with a third embodiment of the present invention;

FIG. 9 is a schematic view showing the transmission of the rack and the gear in accordance with the third embodiment of the present invention;

FIG. 10 is a schematic view of the third embodiment of the present invention used for lifting and lowering a table; and

FIG. 11 is a schematic view showing the transmission of the rack and the gear in accordance with a fourth embodiment of the present invention.

### DETAILED DESCRIPTION OF THE PREFERRED EMBODIMENTS

Embodiments of the present invention will now be described, by way of example only, with reference to the accompanying drawings.

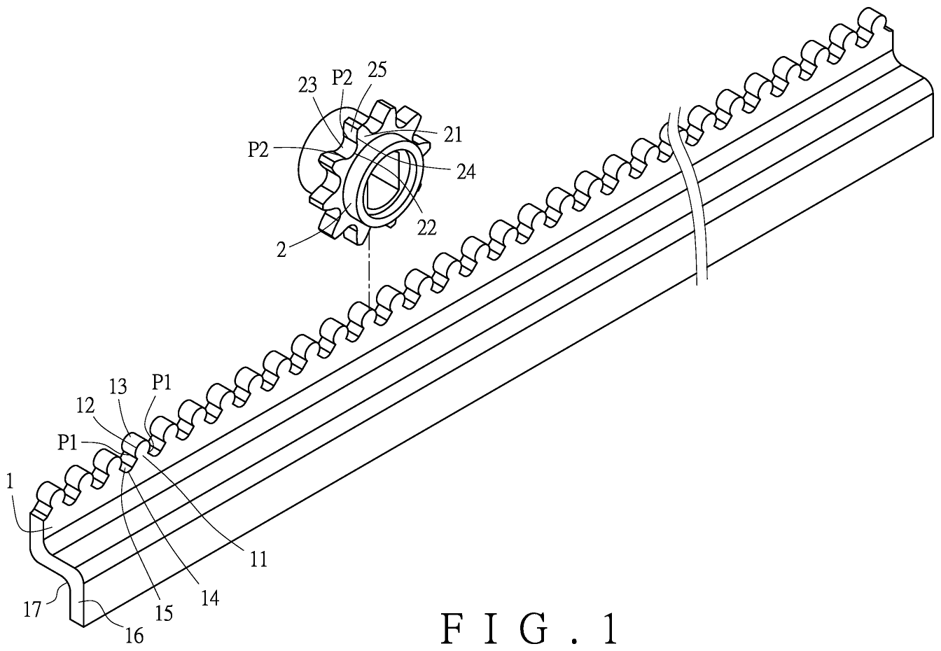

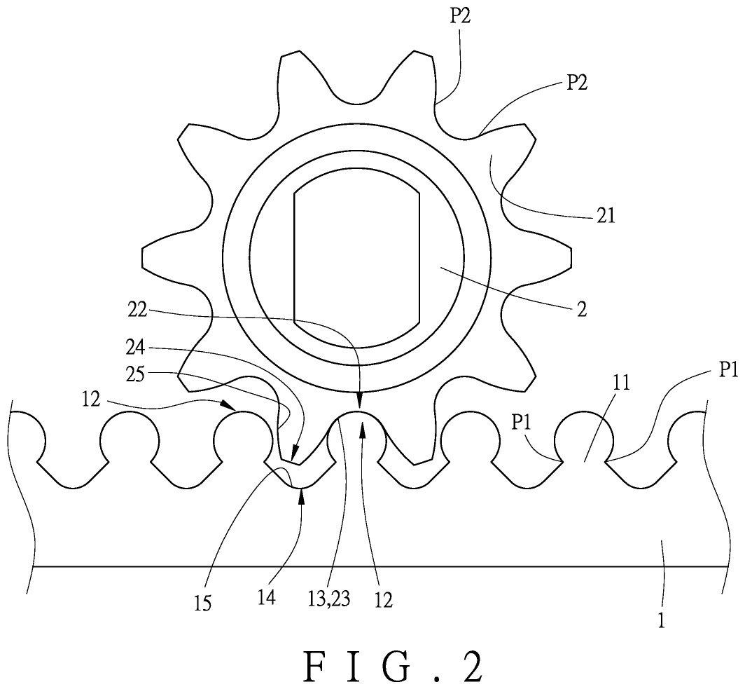

Referring to FIG. 1 and FIG. 2, a first embodiment of the present invention comprises a rack (1) and a gear (2).

The rack (1) includes a plurality of first teeth (11) arranged in a straight line. Each of the first teeth (11) has a first crown portion (12). The first crown portion (12) is defined by a range between any two adjacent first nodes (P1). The surface of the first crown portion (12) is defined as a first contact surface (13) having a circular arc shape. A first root portion (14) is defined between the first crown portions (12) of every adjacent two of the first teeth (11). The surface of the first root portion (14) is defined as a first non-contact surface (15). In addition, the side of the rack (1) is provided with a retaining portion (16) that extends perpendicularly relative to the rack (1) and has an L-shaped cross section.

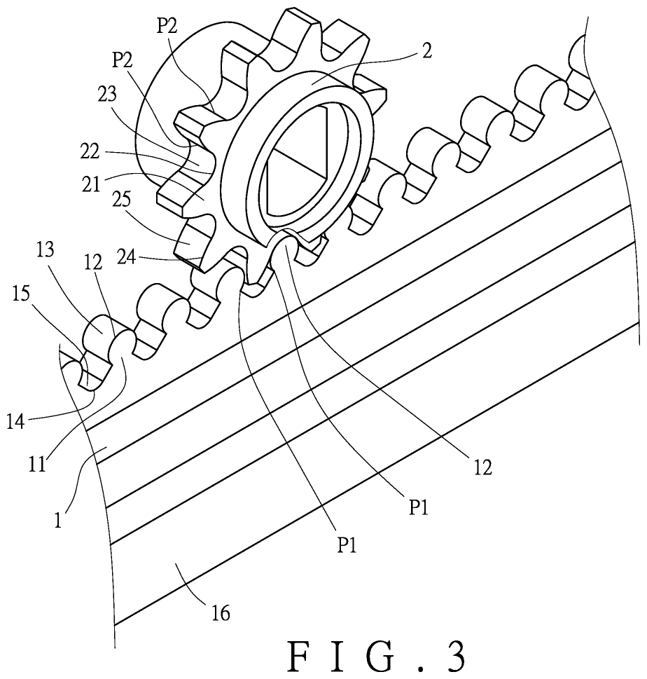

The gear (2) is in mesh with the rack (1) to drive the rack (1) to move linearly. The gear (2) includes a plurality of second teeth (21) arranged around the gear (2). A second root portion (22) is defined between every adjacent two of the second teeth (21). The second root portion (22) is defined by a range between any two adjacent second nodes (P1). The surface of the second root portion (22) is defined as a second contact surface (23) having a circular arc shape. When the gear (2) is meshed with the rack (1), the second contact surface (23) and the first contact surface (13) are in close contact with each other in a circular arc shape (as shown FIG. 3). Each of the second teeth (21) has a second crown portion (24). The surface of the second crown portion (24) is defined as a second non-contact surface (25). When the gear (2) is meshed with the rack (1), the second non-contact surface (25) is not in contact with the first non-contact surface (15).

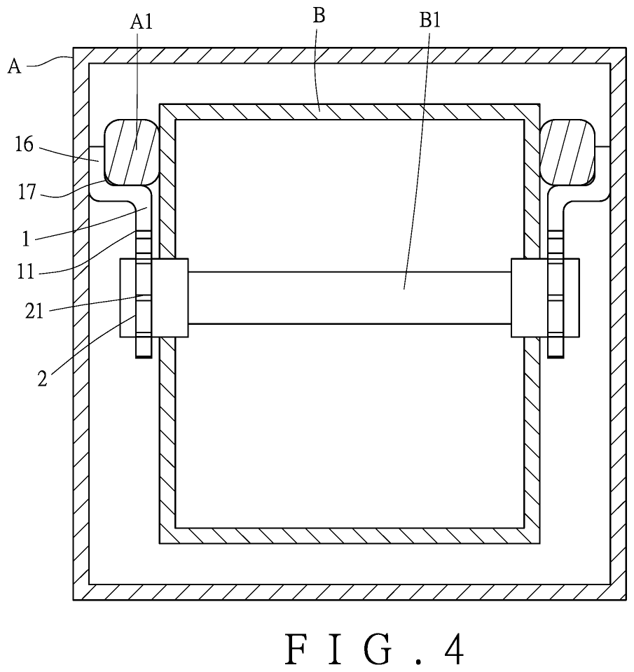

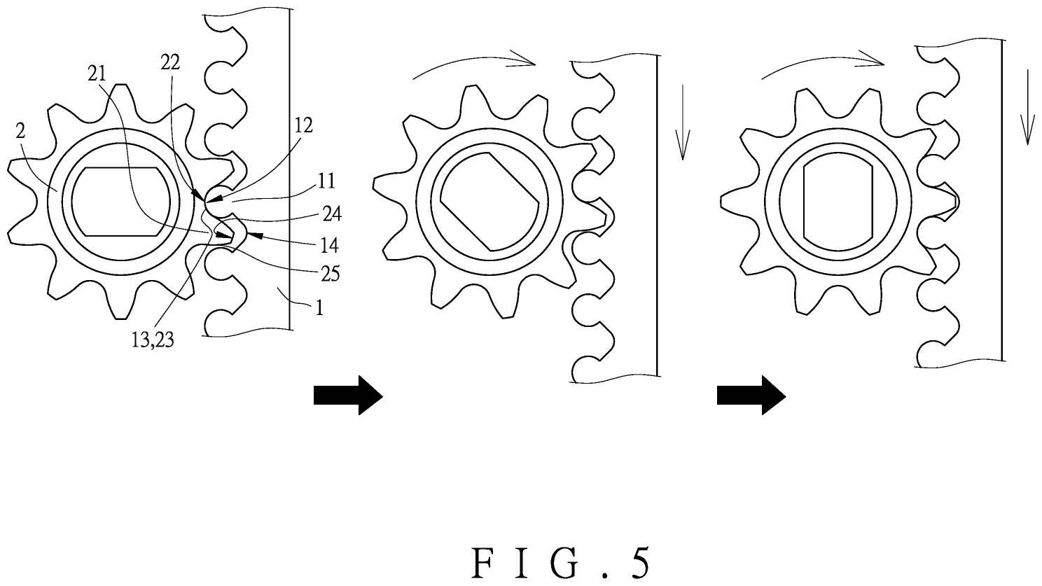

When installed for lifting and lowering a table, as shown in FIG. 4 and FIG. 5, the retaining portions (16) of the two racks (1) are fixed to the opposite inner wall surfaces of an outer tube (A), respectively. The two gears (2) are connected to two ends of a transmission shaft (B1) penetrating the outer wall surfaces of an inner tube (B), respectively. The transmission shaft (B1) is driven by a power source to make the transmission shaft (B1) drive the two gears (2) to rotate synchronously. The two gears (2) are meshed with the two racks (1), respectively. Two guide blocks (A1) are fixed on the two outer wall surfaces of the inner tube (B). The two retaining portions (16) each have an L-shaped bent portion (17) to abut against the corresponding guide block (A1). By the guiding action of the two guide blocks (A1), the outer tube (A) can be stably moved up and down relative to the inner tube (B).

When the transmission shaft (B1) starts to rotate, the two gears (2) are synchronously rotated to move up and down along the respective racks (1). Because the first contact surface (13) of the first crown portion (12) of the rack (1) is close contact with the second contact surface (23) of the second root portion (22) of the gear (2), without any backlash at all, in the transmission process, the transmission of the first teeth (11) and the second teeth (21) is relatively smooth. Since there is no backlash, the noise generated by the transmission contact can be reduced. Moreover, the second contact surface (23) and the first contact surface (13) are in close contact with each other in a circular arc shape, so that there is no disadvantage of uneven force. It does not cause wear or damage to the first teeth (11) and the second teeth (21), so the present invention can prolong the service life and is suitable for use in the lifting unit of any table.

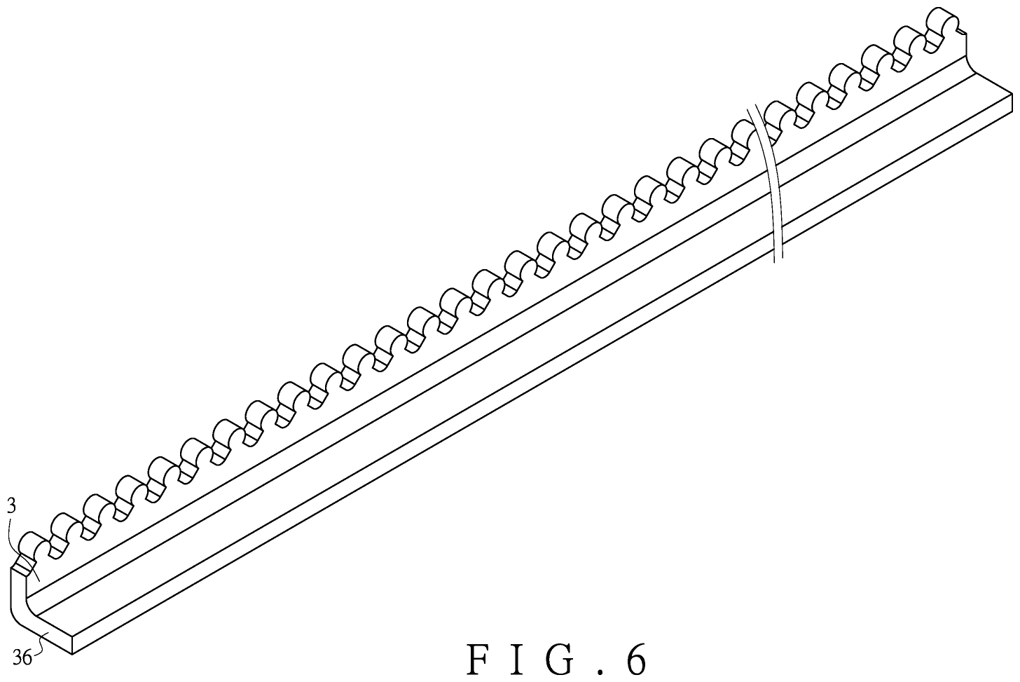

FIG. 6 illustrates a second embodiment of the present invention. The second embodiment of the present invention differs from the first embodiment described above only in that the side of the rack (3) is provided with a retaining portion (36) that extends perpendicularly relative to the rack (3) and has an I-shaped cross section for abutting against the guide block with a different configuration, so that the same effect as the first embodiment can be achieved.

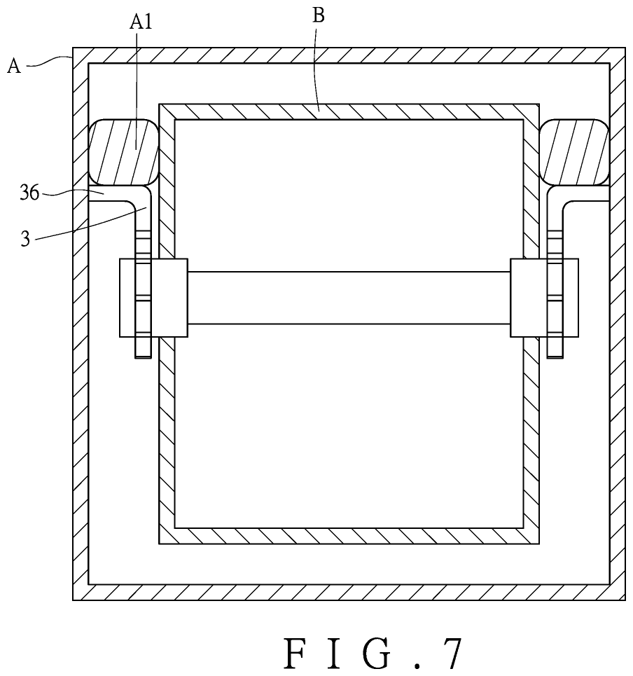

When installed for lifting and lowering a table, as shown in FIG. 7, the retaining portions (36) of the two racks (3) are fixed to the opposite inner wall surfaces of an outer tube (A), respectively. Two guide blocks (A1) are fixed on two outer wall surfaces of an inner tube (B). The two retaining portions (36) abut against the two guide blocks (A1), respectively. By the guiding action of the two guide blocks (A1), the outer tube (A) can be stably moved up and down relative to the inner tube (B).

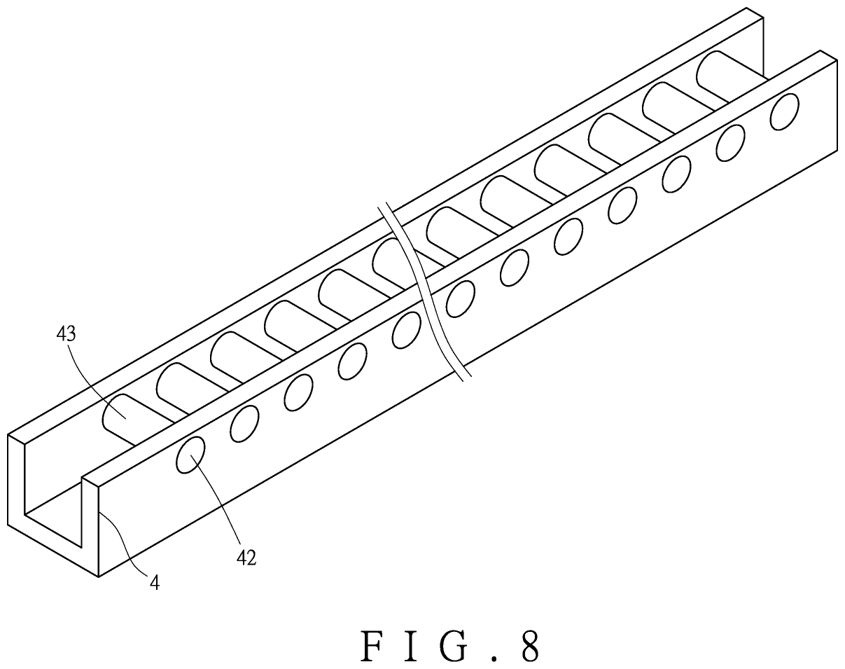

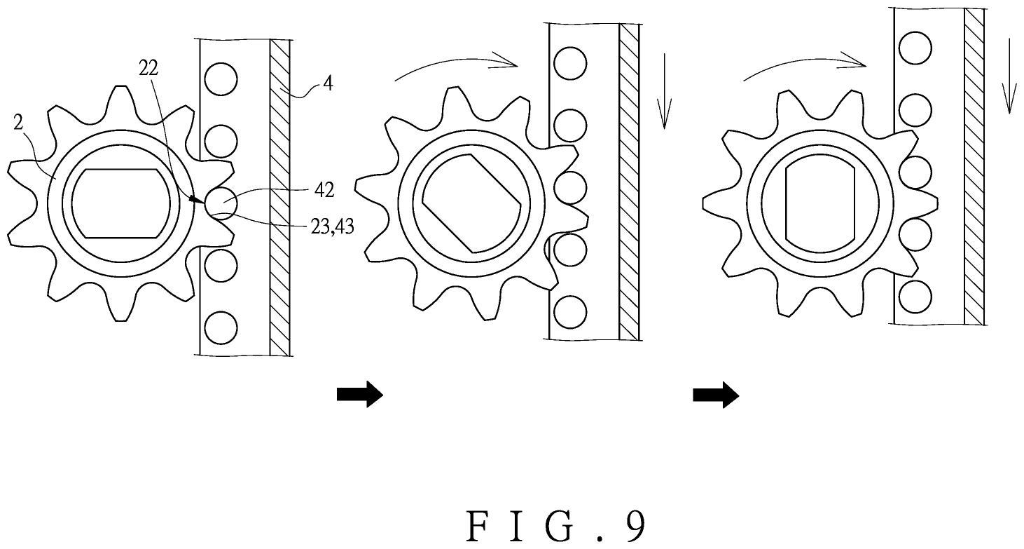

FIG. 8 and FIG. 9 illustrate a third embodiment of the present invention. The third embodiment of the present invention is substantially similar to the first embodiment with the exceptions described hereinafter. The rack (4) is in the form of a U-shaped seat. The first crown portion (42) is a roller spanning the seat. The circumferential surface of the roller is defined as the first contact surface (43) for rotating. The rollers on the rack (4) can be relatively rolled, so that the circumferential surface of each roller is in close contact with the second contact surface (23) of the second root portion (22) of the gear (2), without any backlash at all. Therefore, during the transmission, the transmission contact can be relatively smooth to reduce the noise generated by the transmission contact, thereby achieving the same effect as the first embodiment.

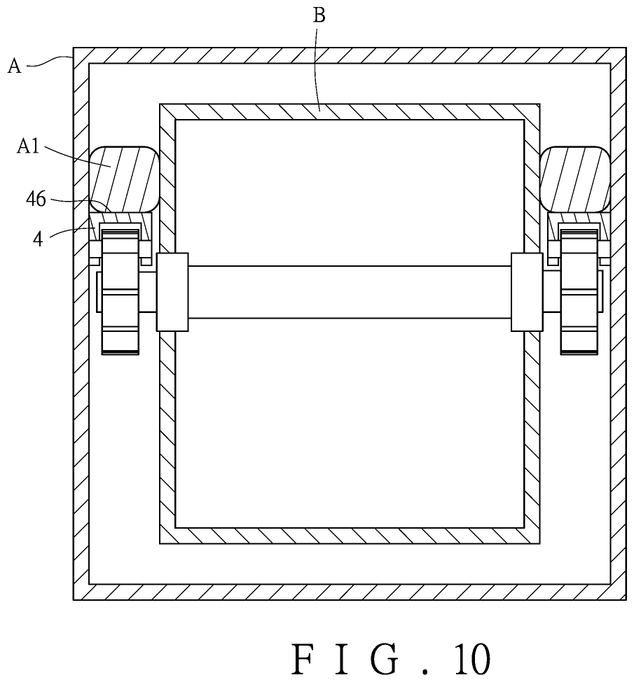

When installed for lifting and lowering a table, as shown in FIG. 10, the two racks (4) are fixed to the opposite inner wall surfaces of an outer tube (A), respectively. Two guide blocks (A1) are fixed on two outer wall surfaces of an inner tube (B). The two racks (4) each have a flat retaining portion (46) to abut against the corresponding guide block (A1). By the guiding action of the two guide blocks (A1), the outer tube (A) can be stably moved up and down relative to the inner tube (B).

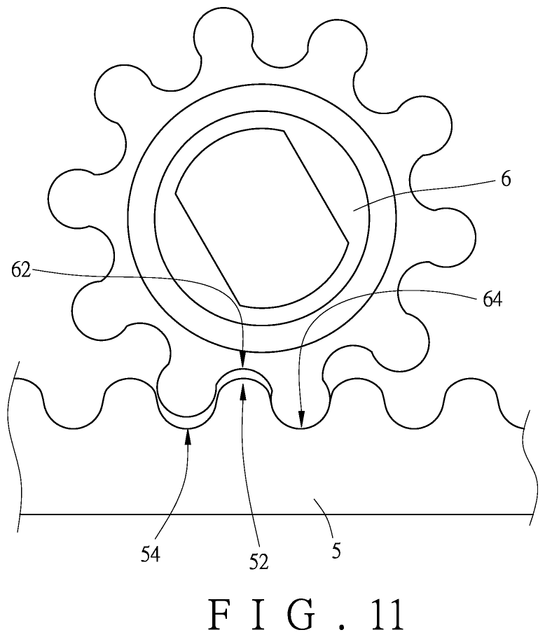

FIG. 11 illustrates a fourth embodiment of the present invention. The fourth embodiment of the present invention is substantially similar to the first embodiment with the exceptions described hereinafter. The first crown portion (52) of the rack (5) and the second root portion (62) of the gear (6) have corresponding arc shapes. The first root portion (54) of the rack (5) and the second crown portion (64) of the gear (6) have corresponding arc shapes. Therefore, during the transmission, the transmission contact can be relatively smooth to reduce the noise generated by the transmission contact, thereby achieving the same effect as the first embodiment.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A low-noise lifting device, comprising:
a rack, including a plurality of first teeth arranged in a straight line, each of the first teeth having a first crown portion, the first crown portion being defined by a range between any two adjacent first nodes, a surface of the first crown portion being defined as a first contact surface having a circular arc shape, a first root portion being defined between the first crown portions of every adjacent two of the first teeth;
a gear, in mesh with the rack, the gear including a plurality of second teeth arranged around the gear, a second root portion being defined between every adjacent two of the second teeth, the second root portion being defined by a range between any two adjacent second nodes, a surface of the second root portion being defined as a second contact surface having a circular arc shape, each of the second teeth having a second crown portion, wherein when the gear is meshed with the rack, the second contact surface and the first contact surface are in close contact with each other in a circular arc shape.

2. The low-noise lifting device as claimed in claim 1, wherein a surface of the first root portion is defined as a first non-contact surface, a surface of the second crown portion is defined as a second non-contact surface, when the gear is meshed with the rack, the second non-contact surface is not in contact with the first non-contact surface.

3. The low-noise lifting device as claimed in claim 1, wherein the rack is provided with a retaining portion that extends perpendicularly relative to the rack and has an L-shaped cross section.

4. The low-noise lifting device as claimed in claim 1, wherein the rack is provided with a retaining portion that extends perpendicularly relative to the rack and has an I-shaped cross section.

5. The low-noise lifting device as claimed in claim 1, wherein the first crown portion is a roller, a circumferential surface of the roller is defined as the first contact surface, and the circumferential surface of the roller is in close contact with the second contact surface.

6. The low-noise lifting device as claimed in claim 5, wherein the rack is in the form of a U-shaped seat, and the roller spans the seat.

7. The low-noise lifting device as claimed in claim 6, wherein the rack is provided with a flat retaining portion.

8. The low-noise lifting device as claimed in claim 1, wherein the first crown portion and the second root portion have corresponding arc shapes.

9. The low-noise lifting device as claimed in claim 1, wherein the first root portion and the second crown portion have corresponding arc shapes.
